(19) United States
(12) Patent Application Publication
(10) Pub. No.: US 2026/0362577 A1
(43) Pub. Date: Nov. 12, 2026

(54) SYSTEM AND METHOD FOR INTEGRATED HIGH VOLTAGE GENERATOR AND X-RAY SOURCE

(71) Applicant: Empyrean Medical Systems, Inc., Boca Raton, FL (US)

(72) Inventors: Dirk Bartkoski, Knoxville, TN (US); Simcha Borovsky, Flemington, NJ (US); Benjamin Insley, Philadelphia, PA (US); Michael Vinogradov, Yavneh (IL); Daniil Kondratyev, Holon (IL)

(21) Appl. No.: 19/468,286

(22) Filed: Feb. 3, 2026

Related U.S. Application Data
(60) Provisional application No. 63/753,109, filed on Feb. 3, 2025.

(51) Int. Cl. H05G 1/32

(52) U.S. Cl. CPC H05G 1/32

(57) ABSTRACT

An X-ray source includes an elongated X-ray tube having an outer surface and an open interior with a cathode and an anode in the open interior and separated by a length L. A target when impacted by the electron beam generates Bremsstrahlung X-ray photons. The cathode and the target define an electron beam path for an electron beam. A voltage multiplier circuit and a field balancing circuit are positioned radially outward from the outer surface of the elongated X-ray tube to a distance that is less than or equal to the distance L, and are axially distributed between the cathode and the anode. The field balancing circuit produces a field balancing electromagnetic field that counteracts the voltage multiplier electromagnetic field such that the electron beam path is unaffected by the voltage multiplier electromagnetic field. A method of generating an X-ray beam is also disclosed.

### CROSS-REFERENCE TO RELATED APPLICATIONS

The present application claims priority to and the benefit of U.S. Provisional Patent Application Ser. No. 63/753,109 which was filed on Feb. 3, 2025. The content of this Provisional Patent Application is incorporated herein by reference in its entirety.

### FIELD OF THE INVENTION

The present invention relates to high voltage generators and X-ray sources.

### BACKGROUND

X-ray beam sources are commonly utilized in the medical field for tomography, external beam radiation therapy, and brachytherapy, as well as many industrial uses. The penetration of X-rays used for these purposes is directly related to the energy of the X-rays created by the source. Sources of high-energy X-ray beams are often large and cumbersome, mainly due to the size of generators, cooling units, and other high-voltage electrical components. The generator circuits necessary to create such voltages produce substantial electromagnetic fields which can interfere with the operation of the X-ray beam source. Accordingly, such circuits require significant clearance and shielding to mitigate interference with the X-ray source. Space in medical facilities is almost always a significant limitation and is also important in many industrial applications.

### SUMMARY

The present document concerns an X-ray source. The X-ray source comprises an elongated X-ray tube, a voltage multiplier circuit, and a field balancing circuit. The X-ray tube has an outer surface, an open interior, and first and second ends. A cathode and an anode are disposed in the open interior. The cathode is nearest the first end. The anode is nearest the second end. The cathode and anode are separated by a length L. A target in the open interior is nearer the second end than the first end. The target comprises a material that when impacted by the electron beam generates Bremsstrahlung X-ray photons. The cathode and the target define an electron beam path for an electron beam. The voltage multiplier circuit comprises capacitors and diodes. The capacitors and diodes of the voltage multiplier circuit and the field balancing circuit are positioned radially outward from the outer surface of the elongated X-ray tube to a distance that is less than or equal to L. The capacitors and diodes of the voltage multiplier circuit and the field balancing circuit are axially distributed between the cathode and the anode. During operation of the X-ray source, the voltage multiplier circuit produces a voltage multiplier electromagnetic field. The field balancing circuit produces a field balancing electromagnetic field that counteracts the voltage multiplier electromagnetic field such that the electron beam path is unaffected by the voltage multiplier electromagnetic field.

The present document also concerns implementing systems and methods of generating an X-ray beam. The methods comprise: obtaining an X-ray source comprising a voltage multiplier circuit and a field balancing circuit that are positioned adjacent to and radially outward from an outer surface of an X-ray tube; generating, by the voltage multiplier circuit, a voltage for operation of the X-ray source and a voltage multiplier electromagnetic field; producing, by the field balancing circuit, a field balancing electromagnetic field that counteracts the voltage multiplier electromagnetic field; and operating the X-ray source to generate X-ray radiation.

The present document further concerns an X-ray source, comprising: an X-ray tube; a voltage multiplier circuit positioned adjacent to and radially outward from an outer surface of an X-ray tube, and configured to generate a voltage for operation of the X-ray source so that X-ray radiation is generated, wherein the voltage multiplier circuit produces a voltage multiplier electromagnetic field; and a field balancing circuit positioned adjacent to and radially outward from an outer surface of an X-ray tube, and configured to produce a field balancing electromagnetic field that counteracts the voltage multiplier electromagnetic field.

### BRIEF DESCRIPTION OF THE DRAWINGS

The present solution will be described with reference to the following drawing figures, in which like numerals represent like items throughout the figures.

FIG. 1 provides an illustration of an X-ray source in accordance with the present solution.

FIG. 2 provides an illustration of the X-ray source shown in FIG. 1 with the voltage multiplier assembly and circuit board removed to facilitate visibility of other components.

FIG. 3 provides an illustration showing an end of the X-ray tube of FIG. 1.

FIG. 4 provides an illustration showing an opposing end of the X-ray tube of FIG. 1.

FIG. 5 provides an illustration of an electron beam path through the X-ray tube of FIG. 1.

FIG. 6 provides a perspective cross-sectional view of the X-ray tube taken.

FIG. 7 provides a side view of the X-ray tube shown in FIG. 1.

FIG. 8 provides an illustration useful for understanding a cathode assembly.

FIGS. 9-10 provide illustrations useful for understanding an anode assembly.

FIGS. 11A-11B (collectively referred to as “FIG. 11”) provide illustrations that are useful for understanding operations of a voltage multiplier circuit and a field balancing circuit of the X-ray tube.

FIG. 12 provides a cross-sectional view of the X-ray tube shown in FIG. 1 taken along line A-A of FIG. 1.

FIGS. 13A-13D (collectively referred to as “FIG. 13”) each provides a circuit diagram of the voltage multiplier circuit.

FIG. 14 provides an illustration useful for understanding the field-balancing circuit.

FIG. 15 provides an illustration showing a generator in which an X-ray tube has a cathode assembly, an anode assembly and a focusing coil.

FIG. 16 provides an illustration of another generator.

FIGS. 17-23 each provides an illustration an X-ray source.

FIGS. 24A-24B (collectively referred to as “FIG. 24”) provides a flow diagram of an illustrative method for operating an X-ray source in accordance with the present solution.

### DETAILED DESCRIPTION

The present solution is described with reference to the attached figures. The figures are not drawn to scale and they are provided merely to illustrate the instant solution. Several aspects of the present solution are described below with reference to example applications for illustration. It should be understood that numerous specific details, relationships, and methods are set forth to provide a full understanding of the present solution. One having ordinary skill in the relevant art, however, will readily recognize that the present solution can be practiced without one or more of the specific details or with other methods. In other instances, well-known structures or operations are not shown in detail to avoid obscuring the present solution. The present solution is not limited by the illustrated ordering of acts or events, as some acts may occur in different orders and/or concurrently with other acts or events. Furthermore, not all illustrated acts or events are required to implement a methodology in accordance with the present solution.

It should also be appreciated that the terminology used herein is for the purpose of describing particular embodiments only and is not intended to be limiting of the present solution. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Terms such as “same,” “equal,” “planar,” “coplanar,” “parallel,” “perpendicular,” etc. as used herein are intended to encompass a meaning of exactly the same while also including variations that may occur, for example, due to manufacturing processes. The term “substantially” may be used herein to emphasize this meaning, particularly when the described embodiment has the same or nearly the same functionality or characteristic, unless the context or other statements clearly indicate otherwise. Additionally, it shall be understood that the term “about” encompasses a variation of at least +/−10% from the example values and relative characteristics provided herein.

Further, unless otherwise defined, all terms (including technical and scientific terms) used herein have the same meaning as commonly understood by one of ordinary skill in the art to which this solution belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An X-ray source that is more compact yet capable of the generation of high energy X-ray beams is desirable. Also, it may be desirable to provide some degree of portability to an X-ray source to allow flexibility in the deployment of that source in various locations, particularly medical facilities. The present solution provides such an X-ray source.

There are three fundamental components of the X-ray source of the present solution an elongated X-ray tube, a voltage multiplier circuit, and a field balancing circuit. The field balancing circuit may also serve another purpose such as a voltage metering circuit.

The first component, the X-ray tube, is the site of X-ray radiation production. X-rays are produced by an energetic electron beam bombarding a target and emitting X-ray photons via the process known as Bremsstrahlung. The X-ray tube Supply contains the following features: cathode assembly, grid electrode, field-defining electrodes, focusing coil, anode assembly, and vacuum chamber. The cathode assembly can be held at ground (0 volts), but this is not required for all X-ray tubes so long as the anode voltage is higher than the cathode voltage. In some scenarios, the cathode can be held at ground. or held at high voltage. In those or other scenarios, there may be a voltage difference between the cathode and the anode where the choice of ground is arbitrary. The cathode assembly is composed of electrical connections to an external circuit which help to establish the ground potential and an electron source. The electron source can, for example, be a thin tungsten filament, but other materials and designs are possible. Alternative thermionic materials include, but are not limited to, Yttria and LaB₆. Non-thermionic sources are also possible and include carbon nanotubes (field emission) and photo injectors (photoelectric sources).

When current is run through the filament of the electron source, heat is generated due to the resistivity of the tungsten. This heat allows electrons to escape the filament through the process of thermionic emission. This process creates an electron cloud hovering around the filament. The anode assembly is positioned some distance from the cathode and is held at some potential higher than the cathode voltage. The exact voltage can vary. The anode and cathode in the X-ray tube are held at different voltages. The anode voltage is higher than the cathode voltage. For example, the anode could be at 1000 kV and the cathode could be at 500 kV. This is equivalent to the anode being at 0 V while the cathode is at −500 kV or the anode is at +500 kV while the cathode is at 0 V. The electric field created by the difference in electric potential between the cathode and anode pulls the electrons from their cloud around the filament and accelerates them towards the anode. The electrons will reach a certain energy determined by the potential difference between the cathode and anode.

Somewhere between the cathode and anode, typically close to the cathode, is the grid electrode. This is a ring-shaped piece of metal that helps shape the emitted electron beam and control the flow of current. While the electron beam is on, the grid will typically have a slightly negative potential to focus the electron beam and prevent electrons from emitting out of the side of the filament. The exact shape of the grid electrode can be optimized to enforce some desired shape on the electron beam. The grid also has another important use—when the electron beam needs to be stopped rapidly, the grid bias can be pushed even more negative. This high negative potential will repel the electrons and not allow them to flow towards the anode.

Downstream of the grid electrode are field-defining electrodes. These are a series of thin, ring-shaped pieces of conducting material (such as copper) that hold some specified voltage between the potential of the cathode and the anode. Each ring will hold a different voltage—the voltages will take steps from ground at the cathode to high voltage at the anode. The purpose of these rings is to help shape the electric field and control its magnitude. Without these rings, higher-voltage tubes that have much longer acceleration lengths will have regions of exceedingly high electric fields and regions of weak electric fields. The rings help smooth the electric field magnitude between cathode and anode.

Also in this region is a magnetic focusing coil. This is composed of a series of current-carrying coils that create a magnetic field within the X-ray tube. This magnetic field helps focus the electron beam to a specific size/shape.

The combination of the filament shape/size, grid electrode, field-defining electrodes, and focusing coil directs the electron beam towards a specific part of the anode assembly known as the X-ray target. This X-ray target is typically a high-atomic-number foil such as tungsten, gold, molybdenum, etc., although other materials and combinations of materials are possible. The X-ray target, for example tungsten, is the site of X-ray production. It is highly important that the electron beam strikes the target in a deliberate, controllable manner. Where exactly the electrons hit the anode will determine the shape of the X-ray field, the energy of the X-ray field, and the deposition of heat within the anode.

The target can operate as a ‘transmission’ target-the useful X-ray field is emitted along the same direction as the electron beam. The present solution may also be used with another type of target—a ‘reflection’ target—where the useful X-ray field is emitted perpendicular to the electron beam.

As the electron beam bombards the X-ray target, the majority of the energy of the electrons is deposited within the target as heat. This heat must be dissipated rapidly, otherwise the target temperature will increase dramatically, possibly leading to the destruction of the target. There are many structures and methods for dealing with this heat deposition. In one example, the tungsten target is in contact with a diamond plate substrate underneath it. This diamond plate substrate helps move the deposited heat quickly. Both the target and diamond plate are clamped within an aluminum heat sink, which is also part of the anode assembly and is at high voltage. This aluminum heat sink accepts the heat from the target and diamond plate and emits it to the environment as thermal radiation. Other designs can include conductive heat dissipation in the form of heat transfer with a cooling medium such as water flowing around the outside of the heat sink. Combinations of heat dissipation by thermal radiation and conductive heat dissipation are also possible.

The cathode, grid, anode, and field-defining electrodes are within the vacuum chamber created by the elongated and evacuated glass tube. Maintaining high vacuum is important for allowing the electrons to flow freely from cathode to anode. Any particles present in the tube can cause a number of problems, including arcing, scattering of the electron beam, and bombarding the cathode with positive ions. The magnetic focusing coil can be positioned outside of the vacuum chamber.

The multiplier circuit can be provided on a circuit board or other suitable support structure. In one example, an alternating current high voltage power supply (AC HVPS) provides ~40 kV. This voltage may be multiplied to create a high energy X-ray beam, for example up to 500 kV direct current or more. A voltage multiplier circuit contains an arrangement of capacitors and diodes. The capacitors store charge while the diodes only allow current to flow in one direction. Placing these capacitors and diodes in the proper arrangement allows for the multiplication of the voltage by the following process. The AC HVPS starts charging the first capacitor. Once the voltage waveform begins to drop, the first capacitor will want to discharge its stored charge to ground. One of the diodes prevents this discharge to ground. Instead, the capacitor discharges to another capacitor. When the AC HVPS voltage waveform flips its current direction, it will charge that other capacitor. This other capacitor experiences the same thing—it cannot discharge to ground because of the diode, so it instead discharges to the other capacitor. This exchange of charge eventually leads to a steady-state where the output capacitor has stored double the charge, and thus double the voltage, of the initial input. Many of these voltage multiplier circuits may be connected together, such that 40 kV AC can be multiplied to 500 kV DC or more. One end of the multiplier board may be connected to the HVPS, while the other end with high voltage is connected to the anode.

The final component is the field balancing circuit. The field balancing circuit can include, but is not limited to, a voltage metering or sample circuit. The voltage metering circuit may be a chain of resistors connected from the anode to the cathode. The resistance of the voltage metering circuit should be so high that the current that is passed is much lower than the X-ray tube current. If too much current is passed through, it will discharge the multiplier circuit and eliminate the voltage difference between cathode and anode. The purpose of this voltage metering circuit is to measure the voltage difference between cathode and anode.

In a typical X-ray tube assembly, it is desired to keep the X-ray tube as separate from the voltage multiplier and sample circuits as possible. This is because the electron beam is highly sensitive to external electromagnetic fields. The voltage multiplier and voltage meter circuits generate their own electromagnetic fields by the storage of charge and passage of current. It is common for X-ray tubes to be shielded from external electromagnetic interference (EMI) using an EMI shield, also known as a Faraday cage. This is a box composed of conducting metal. Oftentimes, a wire cage is sufficient. Since the shield is conducting, its internal charges move freely. External electromagnetic fields push these internal charges into an arrangement that exactly cancels out the external fields—thus, internal components are protected from these external fields. The shield is typically grounded to create a safe pathway for any transient electric currents generated within the shield. Unfortunately, this grounded shield needs to be far enough away from the cathode and anode to not perturb the internal applied electromagnetic fields itself. It is good practice to keep the radius of this shield at least as large as the distance separating the cathode from the anode. Then, the voltage multiplier circuit and the voltage metering circuit, usually on circuit boards, are stored outside this shield, and any necessary electrical connections are fed in through leads.

This assortment may be reasonable for low energies where the cathode-anode distance is minimal. However, as the energy increases, so must the tube length, and thus the entire assembly grows rapidly. The present solution eliminates (i) the need for EMI shielding and (ii) the positioning of the voltage multiplier circuit and the voltage meter circuit away from the tube. A specific arrangement of the multiplier and sample boards and a high density of field-defining electrodes is provided. The voltage multiplier circuit and voltage metering circuits are stretched along the long axis of the tube such that the voltages along the longitudinal axis are similar within the tube and within the boards. Matching the longitudinal position of board and tube voltages minimizes the radial voltage gradients, and thus minimizes the radial electric field (i.e., the component of the electric field that would deflect the electron beam into the side of the tube instead of down the long axis of the tube). Next, the voltage multiplier circuit and voltage metering circuits are positioned opposite each other such that any influence from either circuit is cancelled out by the presence of the other. Finally, the field-defining electrodes are placed inside the vacuum chamber with relatively high frequency and a small inner radius. These electrodes help do some of the shielding that a Faraday cage might be used for. They act as guides for the electron beam and negate any remaining influence from the external circuits.

The present solution eliminates (i) the necessity for an EMI shield and (ii) the need for separate boxes for the voltage multiplier and voltage meter circuits. The overall X-ray tube footprint can be much more compact and allows for implementation into applications with tight space requirements such as preclinical cabinet irradiators. In some scenarios, there is no EMI shield between the voltage multiplier circuit or the field balancing circuit and the X-ray tube.

An X-ray source according to the present solution may include an elongated X-ray tube having an outer surface, an open interior, and first and second ends. A cathode and an anode are provided in the open interior, wherein the cathode is nearest the first end and the anode is nearest the second end. The cathode and anode are separated by a length L. A target is provided in the open interior nearer the second end than the first end. The target comprises a material that when impacted by the electron beam generates Bremsstrahlung X-ray photons. The cathode and the target define an electron beam path for an electron beam. A voltage multiplier circuit comprises capacitors and diodes arranged to generate the necessary high voltage for the operation of the X-ray source.

A field balancing circuit is provided to counteract the electromagnetic field generated by the voltage multiplier circuit. The voltage multiplier circuit and the field balancing circuit are positioned radially outward from outer surface of the elongated X-ray tube, and distanced from the electron beam path to a distance that is less than or equal to the distance L. The voltage multiplier circuit and the field balancing circuit are axially distributed between the cathode and the anode. During operation of the X-ray source, the voltage multiplier circuit produces a voltage multiplier electromagnetic field. The field balancing circuit produces a field balancing electromagnetic field that counteracts the voltage multiplier electromagnetic field such that the electron beam path is unaffected by the voltage multiplier electromagnetic field.

The voltage multiplier circuit and the field balancing circuit may be positioned radially outward from the outer surface of the elongated X-ray tube to a distance from the electron beam path that is less than the distance L. The voltage multiplier circuit and the field balancing circuit may be positioned radially outward from the outer surface of the elongated X-ray tube to a distance from the electron beam path that is, for example, 0.001 L, 0.025 L, 0.050 L, 0.075 L, 0.10 L, 0.125 L, 0.150 L, 0.175 L, 0.200 L, 0.225 L, 0.250 L, 0.275 L, 0.300 L, 0.325 L, 0.350 L, 0.375 L, 0.400 L, 0.425 L, 0.450 L, 0.475 L, 0.500 L, 0.525 L, 0.550 L, 0.575 L, 0.600 L, 0.625 L, 0.650 L, 0.675 L, 0.700 L, 0.725 L, 0.750 L, 0.775 L, 0.800 L, 0.825 L,0.850 L, 0.875 L, 0.900 L, 0.925 L, 0.950 L, 0.975 L, or L. The distance of the voltage multiplier circuit and the field balancing circuit can be within a range of any high value and low value selected from these values. The voltage multiplier circuit and the field balancing circuit can be positioned directly at and in contact with the outer surface of the elongated X-ray tube. The distance that the voltage multiplier circuit and the field balancing circuit are distanced from the outer surface of the elongated X-ray tube can be the same or a different value, so long as the electromagnetic fields emanating from these circuits are sufficiently balanced so as not to interfere with the path of the electron beam.

The field balancing circuit may be a circuit designed specifically to produce a field balancing electromagnetic field that counteracts the voltage multiplier electromagnetic field. Alternatively, the field balancing circuit may be a circuit that performs an additional function. For example, the field balancing circuit may comprise a chain of electrical components (e.g., resistors, capacitors, inductors, etc.) configured to generate a field and/or a voltage meter circuit comprising a series of resistors electrically connected between the anode and the cathode for measuring the voltage between the anode and the cathode. The output of the voltage meter circuit is fed back to the controller for selectively adjusting operations parameters for the X-ray source (e.g., electrical voltage supplied across the anode and cathode) and/or for determining characteristics of the electron beam.

The manner in which the voltage multiplier circuit and the field balancing circuit are mounted into position can vary. The voltage multiplier circuit and the field balancing circuit may each be mounted to a circuit board which is in turn connected to the elongated X-ray tube or secured in position close by the elongated X-ray tube. Other means for constructing and mounting these circuits in a desired position are possible. A portion of the voltage multiplier circuit may comprise capacitors and diodes that are directly affixed to the outer surface of the elongated X-ray tube. The field balancing circuit may be affixed to the outer surface of the elongated X-ray tube. The voltage multiplier circuit and the field balancing circuit may be fixed in position by suitable means such as fasteners, adhesives and the like.

The elongated X-ray tube may be considered as having longitudinal half sections. The voltage multiplier circuit and field balancing circuit are positioned radially outward from different ones of the longitudinal half sections. The electromagnetic fields emanating from these circuits are thereby opposing. The nature of the voltage multiplier circuit is that the voltage is multiplied with progress through the circuit, which can be up to 500 kV or more. The generated electromagnetic field increases as the voltage increases from the cathode to the anode. The voltage of the field balancing circuit steps with the voltage of the voltage multiplier circuit, such that radial differences in voltage across the X-ray tube are avoided and electromagnetic fields which would be created by such radial voltage differences are also avoided.

The anode in some scenarios is the target or is connected directly to the target. The target can alternatively be electrically separated from the anode.

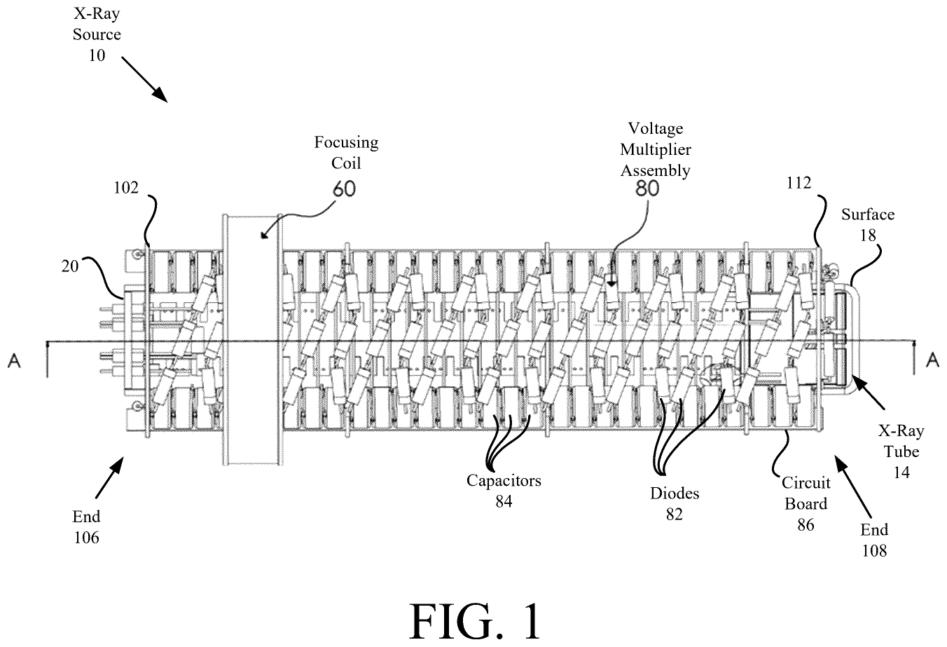

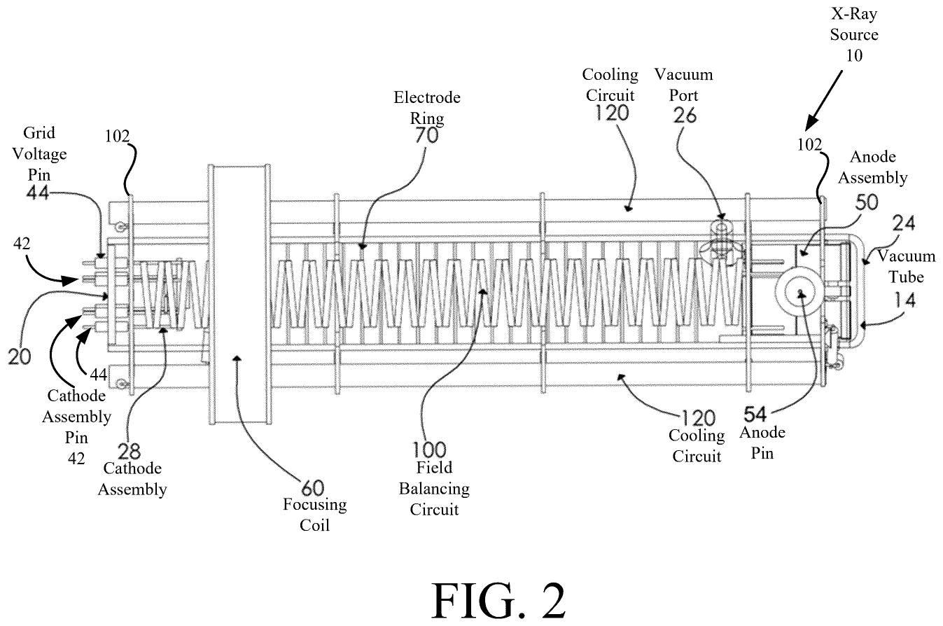

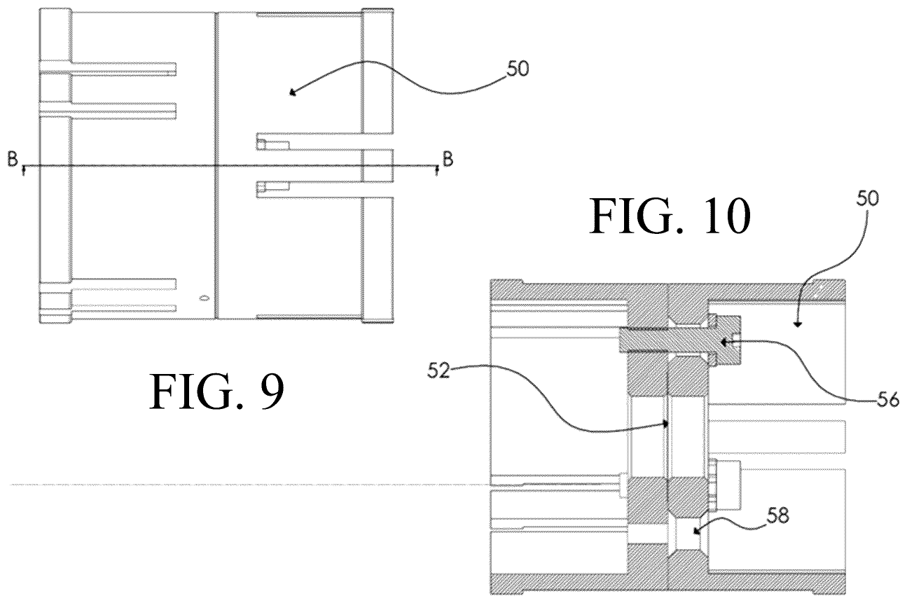

FIGS. 1-13 provide illustrations of an X-ray source 10 in accordance with the present solution. X-ray source 10 comprises an elongated X-ray tube 14 having an outer surface 18, a first end 106 and a second end 108. A vacuum port 26 (see FIG. 2) can be provided to evacuate the interior of the X-ray tube 14.

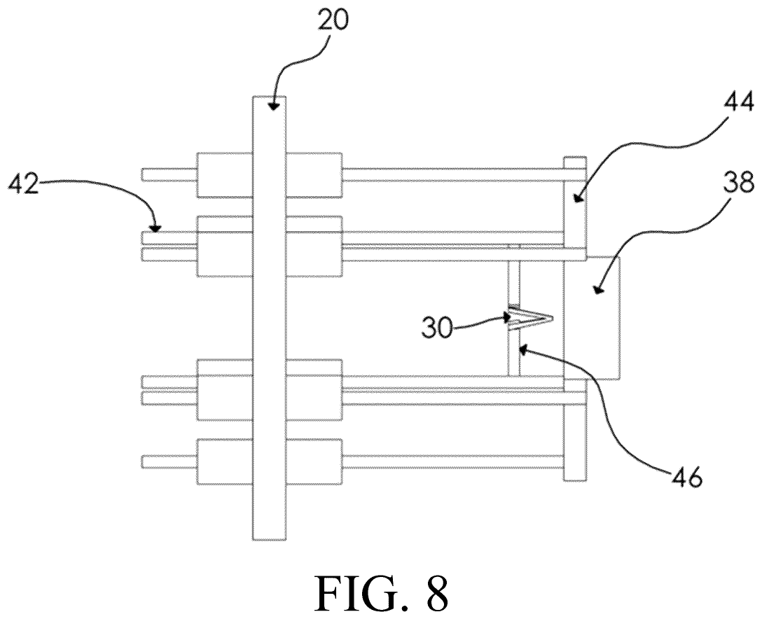

A cathode assembly 28 is provided inside the first end 106 of the X-ray tube 14. Cathode assembly 28 is visible in FIGS. 2, 3, 5, 7 and 8. Cathode assembly 28 comprises a filament (or cathode) 38, a focusing grid 30, cathode assembly pins 42, grid voltage pins 44, and filament voltage pins 46 (see FIG. 8). Cathode assembly pins 42 and grid voltage pins 44 may be mounted on, coupled to or otherwise supported by end structure 20 of the X-ray source 10. The filament (or cathode) 38 emits electrons which will form the electron beam. The focusing grid 30 focuses the electron beam and prevents electrons from emitting out of the side of the filament (or cathode) 38. Focusing grid 30 may also be used to stop the electron beam. Cathode assembly pins 42 provide pin connections for the cathode in X-ray tube 14. Grid voltage pins 44 connect an internal electrode configured to regulate or control the flow and focus of electrons. Filament voltage pins 46 connect to a filament circuit. The filament circuit is configured to provide current to heat the filament (or cathode) for causing thermionic emission (i.e., release a cloud of electrons).

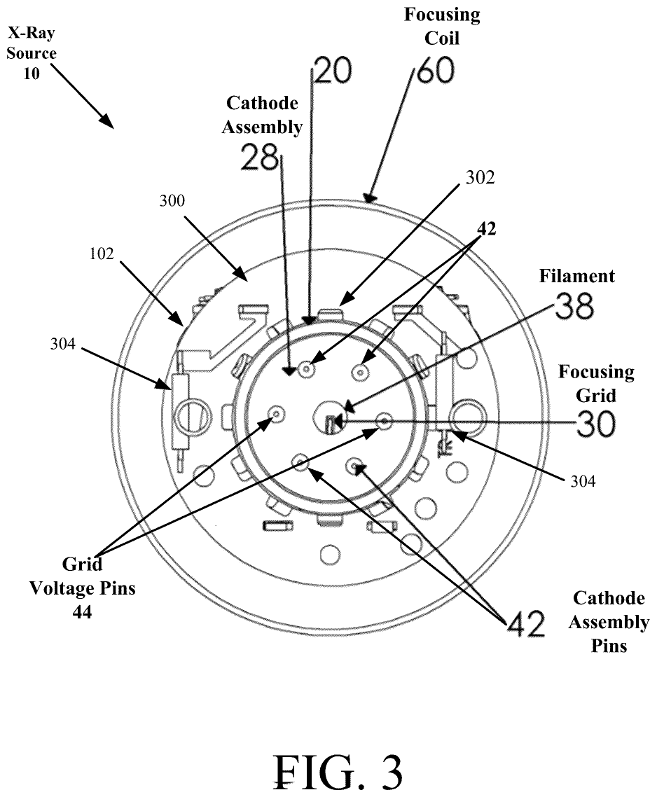

Cathode assembly 28 also comprises a plate 300 with a plurality of cutouts 302 as seen in FIG. 3. Cutouts 302 are provided to maintain the assembly centered with an open path for a cooling liquid to flow around the X-ray tube 14. Passive element 304 are coupled to plate 300 as also shown in FIG. 3. Passive elements 304 comprise hi power resistors coupling a driver transformer to the voltage multiplier assembly 80.

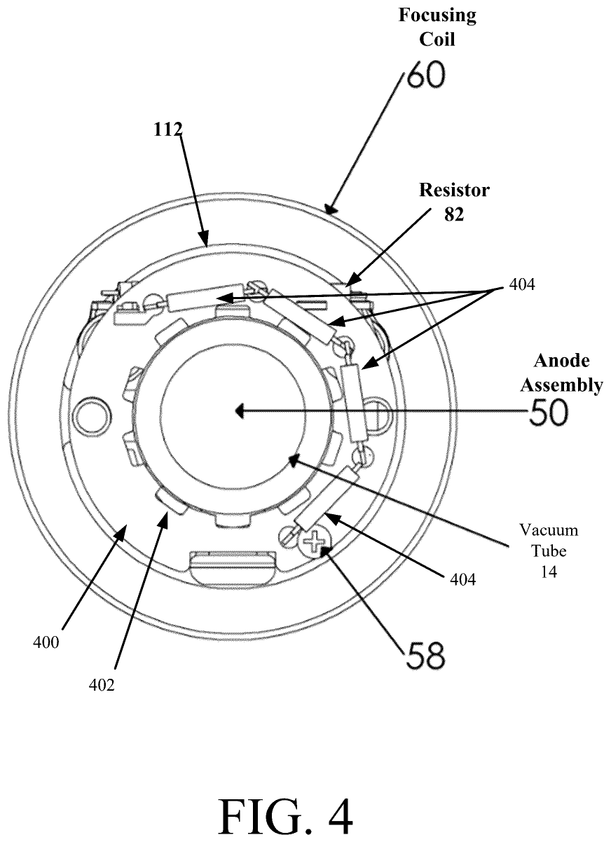

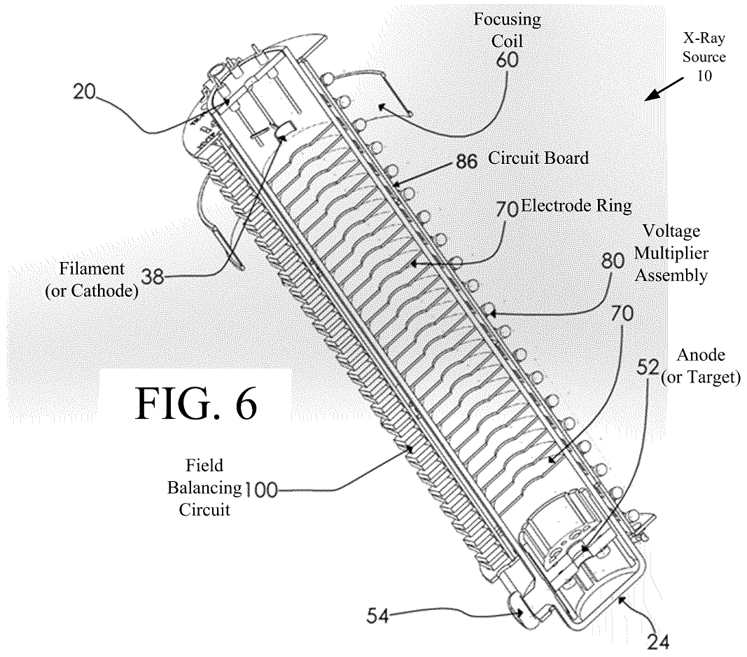

An anode assembly 50 is provided inside the second end 108 of the X-ray tube 14. Anode assembly 50 is visible in FIGS. 2, 4-7, 9 and 10. Anode assembly 50 comprises the anode serving as the target 52 (see FIG. 6) where electrons from the filament (or cathode) 38 strike to convert kinetic energy into X-rays. The present solution is not limited to this architecture. In some scenarios, the target and anode can be separated. An anode pin 54 provides electrical connection to the anode assembly 50. The anode assembly 50 can be secured inside the X-ray source 10 via couplers. The couplers can include, but are not limited to, screws 56 and 58 (see FIGS. 4 and 10).

Anode assembly 50 also comprises a plate 400 with a plurality of cutouts 402, as seen in FIG. 4. Cutouts 302 are provided to maintain the assembly centered with an open path for a cooling liquid to flow around the X-ray tube 14. Passive element 404 are coupled to plate 400. Passive element 404 comprises a plurality of resistors that are connected in series to increase flash over protection for the X-ray source 10.

A focusing coil 60 is provided at end 106 of X-ray tube 14 near cathode assembly 28. Focusing coil 60 is configured to create a magnetic field within the X-ray tube 14. This magnetic field helps to focus the electron beam to a specific size and/or shape.

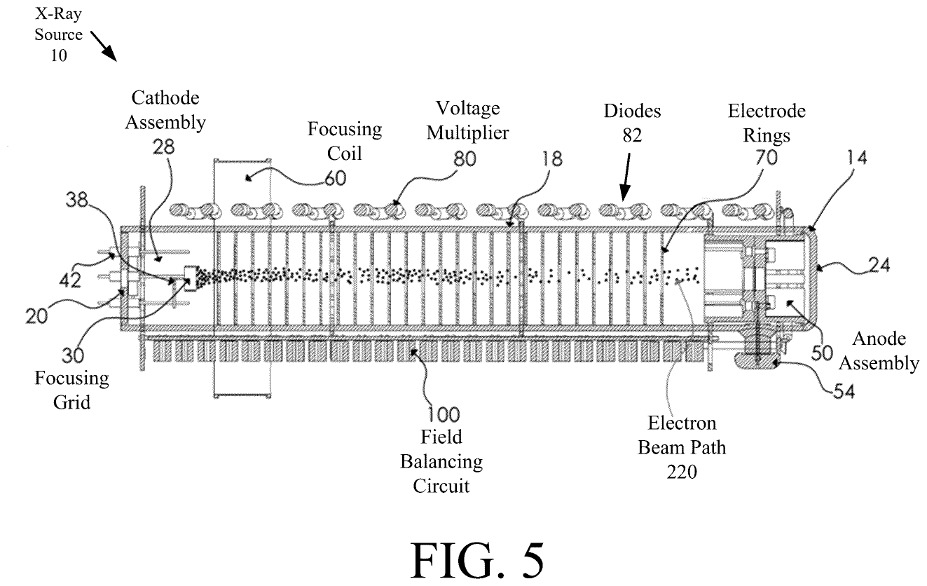

As seen in FIG. 5, field defining electrode rings 70 are also provided within the elongated X-ray tube 14. The field defining electrode rings 70 comprise a series of thin, ring-shaped pieces of conducting material that each hold some specified voltage between the potential of the cathode 38 and the anode 52. The field defining electrode rings 70 help shape the electron beam path 220 and control its magnitude, to help smooth the electric field magnitude between cathode 38 and anode 52.

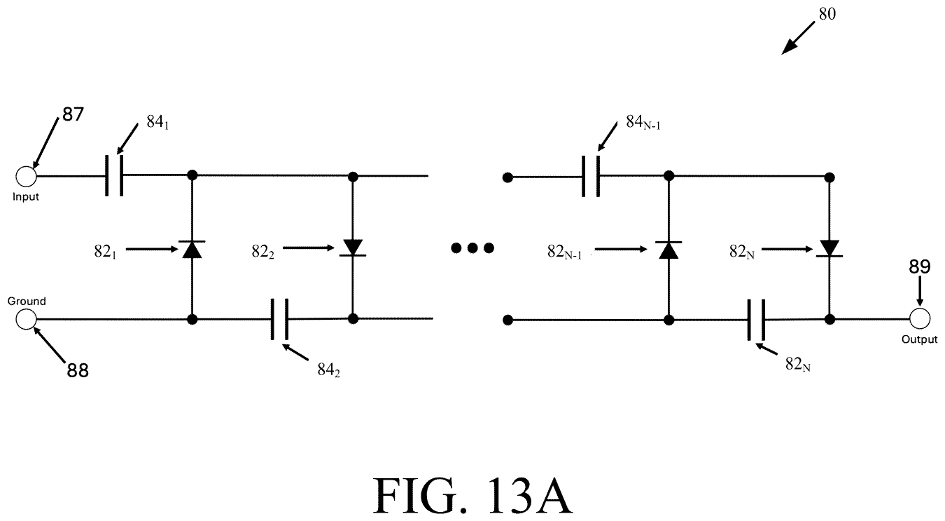

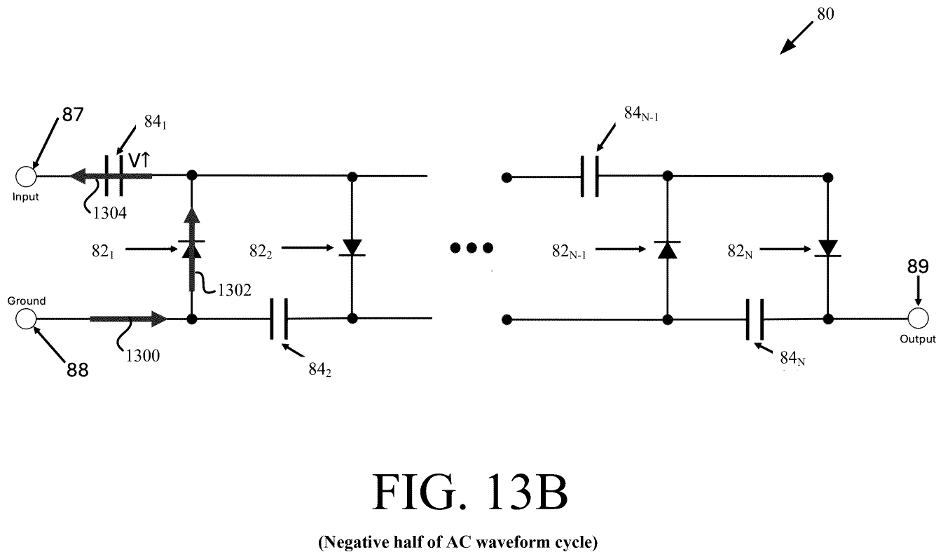

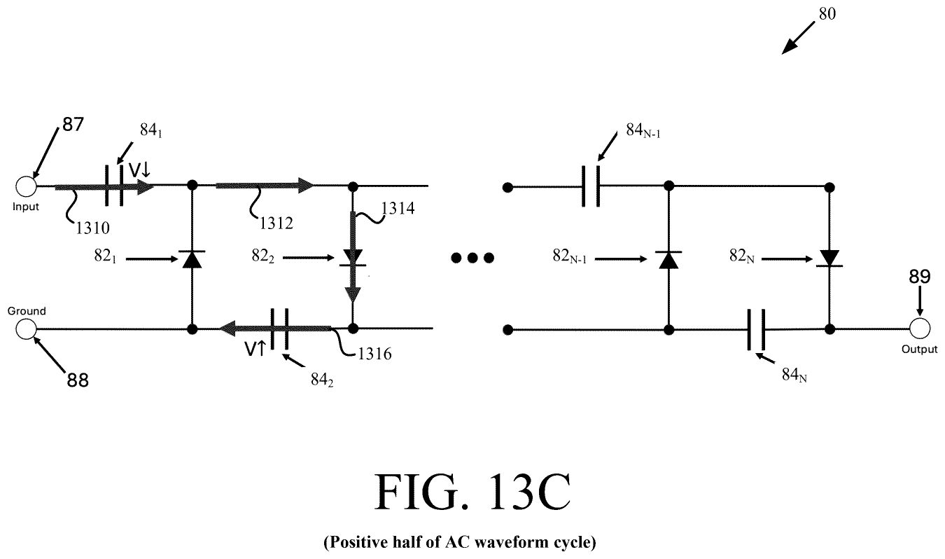

A voltage multiplier assembly (or circuit) 80 is affixed at, on, adjacent to, or near the outer surface 18 of the elongated X-ray tube 14. An illustrative circuit diagram of the voltage multiplier assembly 80 is provided in FIG. 13A. As shown in FIG. 13A, the voltage multiplier assembly 80 may comprise diodes 82₁, 82₂, . . . , 82_{N-1}, 82_{N} (collectively referred to as “82”) and capacitors 84₁, 84₂, . . . , 84_{N-1}, 84_{N} (collectively referred to as “84”). Voltage multiplier circuit 80 can also include input lines or terminals 87,88 and an output line or terminal 89. Input line 88 is connected to ground. The capacitors 84 store charge while the diodes 82 allow current to flow in one direction.

Operation of the voltage multiplier assembly (or circuit) 80 will now be described with reference to FIGS. 13B-13D. Current flow during a first phase is shown in FIG. 13B by arrows 1300, 1302, 1304. Current flow during a second phase is shown in FIG. 13C by arrows 1310, 1312, 1314, 1316. Current flow during a third phase is shown in FIG. 13D as shown by arrows 1320, 1322, 1324, 1326, 1328. In the first phase, the AC waveform is in its negative half cycle. As such, current flows from line 88 to capacitor 84₁ via diode 82₁. Capacitor 84₁ is charged by this current. Diode 82₂ prevents charging of capacitor 84₂. In the second phase, the AC waveform is in its positive half cycle. Since diode 82₁ is inactive, capacitor 84₁ discharges into capacitor 84₂ through diode 82₂. This magnifies the charge buildup in capacitor 84₂. In the third phase, the AC waveform is in its negative half cycle. Diode 82₂ prevents capacitor 84₂ from discharging into capacitor 84₁, so enhanced voltage is passed on (either to output 89 or to the next stage of circuit 80). Capacitor 84₁ is once again charged by input, allowing another round of multiplication. After several cycles, the output converges to a multiplied DC voltage with minimal current. This leads to a steady-state where the output capacitor 84_{N} has stored double the charge, and thus double the voltage of the initial input. This process repeats through the circuit to increase the voltage to the desired output voltage. The voltage multiplier circuit 80 can be mounted on a printed circuit board (PCB) 86, or on other suitable structure.

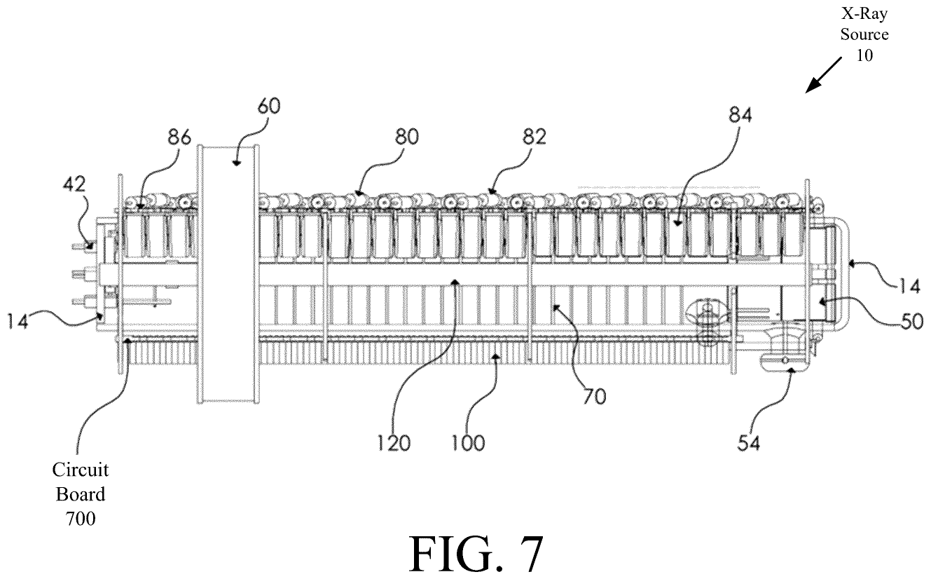

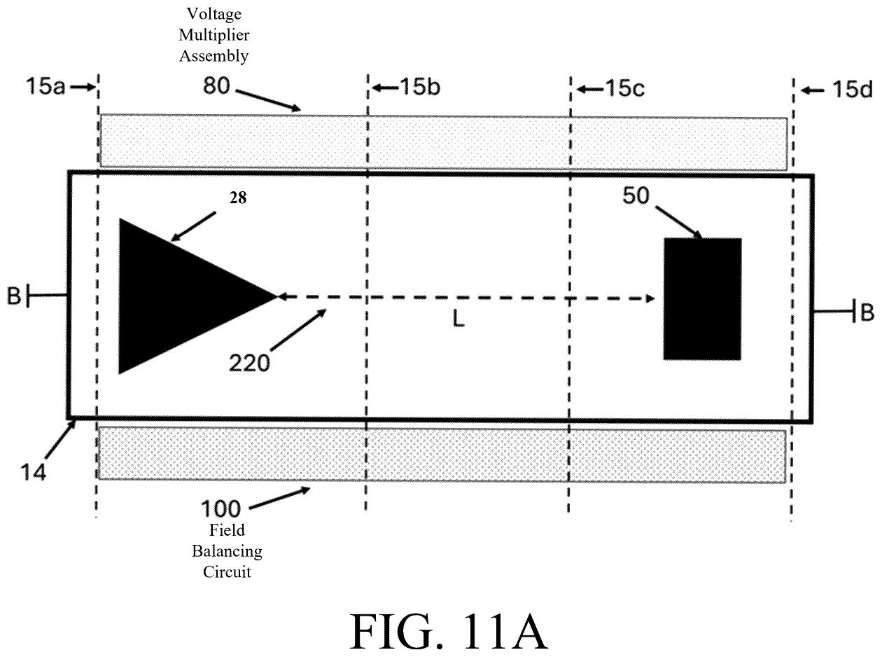

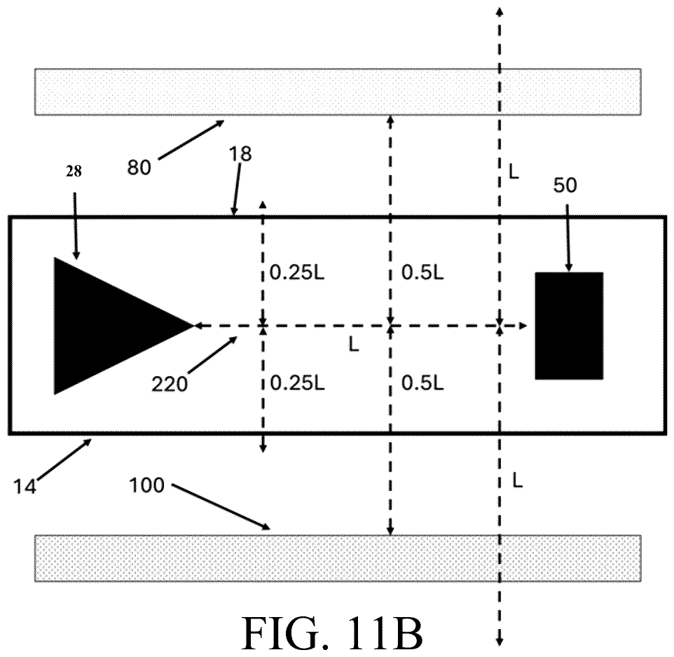

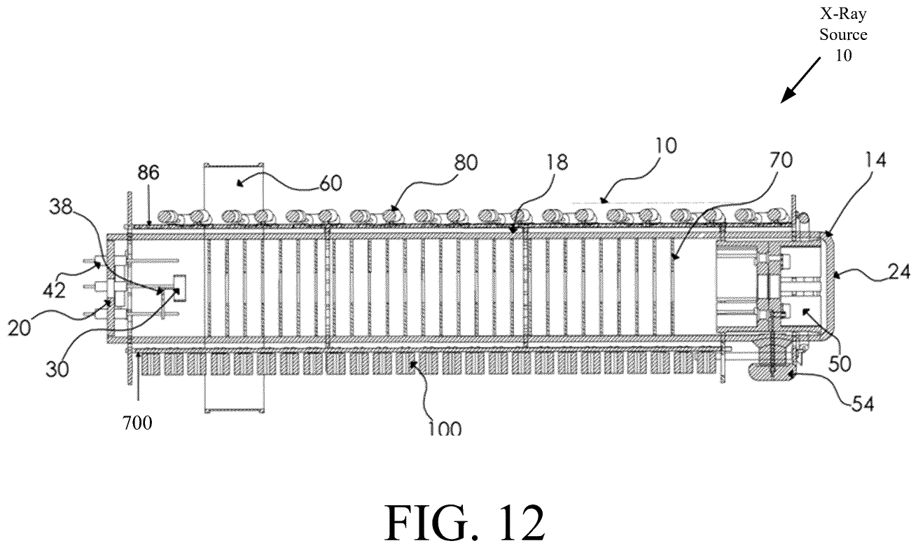

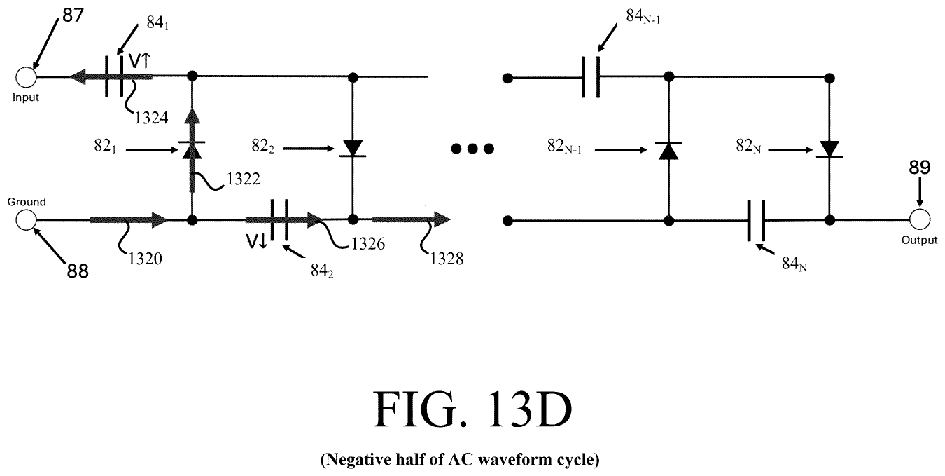

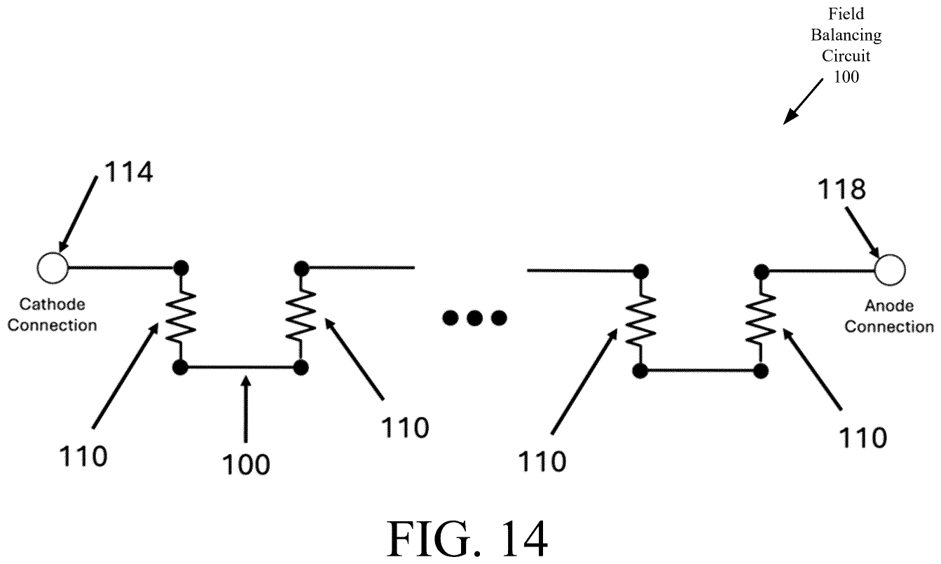

Field-balancing circuit 100 is positioned on an opposite side of the X-ray tube 14 relative to the side on which the voltage multiplier assembly (or circuit) 80 resides. For example, field-balancing circuit 100 may be positioned on an opposite longitudinal half of the X-ray tube 14 as indicated by the longitudinal plane B in FIG. 11A. The field-balancing circuit 100 need not be perfectly opposite to the voltage multiplier circuit 80, only sufficiently so to provide the opposing electromagnetic field. Field balancing circuit 100 can include, but is not limited to, a voltage meter circuit. The voltage meter circuit may be mounted on a PCB 700 (see FIGS. 7 and 12) or other suitable structure of the X-ray source 10. FIG. 14 provides an illustrative circuit diagram for field-balancing circuit 100. As seen in FIG. 14, field-balancing circuit 100 can comprise a series of resistors 110 positioned between a cathode connection 114 and an anode connection 118. Cooling of the target 52 may be provided by a suitable cooling circuit 120 (see FIGS. 2 and 7) which can be a flowing chilled water or other cooling system.

As shown in FIG. 11A, the shortest path for an electron beam path 220 between the cathode assembly 28 and anode assembly 50 is a distance L. The present solution permits the provision of the voltage multiplier circuit 80 within a distance from the outer surface 18 of the X-ray tube 14 that is less than or equal to L, as shown in FIG. 11B. This is substantially due to the presence of the field balancing circuit 100 and the counteracting electromagnetic field. This may also be due to the presence of the field-defining rings 70.

In general, an electric field is only produced when there are non-uniformities in voltage. For example, if point A is at 100 V and point B is at 100 V, then there is no electric field pointing from point A to point B or vice versa. In other words, an electron at point A will not feel a force towards point B. If point C is at 200 V, then an electron at point A will accelerate towards point C. Any changes in voltage throughout the X-ray tube result in an electric field pointing in the direction of the voltage change. Some of these voltage non-uniformities are deliberate—for instance, a voltage difference is intentionally established between cathode and anode with the anode at a higher voltage so that an electron starting at the cathode will accelerate towards the anode. The circuits around the side of the X-ray tube have components that hold different voltages. Those voltages pull charges through these various components, much like electrons flowing through a conductor. However, electric fields also emanate from the circuit components outside the X-ray tube and can affect adjacent structures, such as the electron beam within the X-ray tube. For example, if the voltage multiplier assembly 80 circuit and field balancing circuit 100 are misaligned such that voltages at some longitudinal point, Z, are not equivalent in the voltage multiplier circuit and field balancing circuit, there will be an electric field line pointing across the X-ray tube 14 in the radial direction, created by the uneven voltages.

Referring to FIG. 11A, if voltage is constant across the X-ray tube 14 at various locations represented by dotted lines 15a-d (the dotted lines are equipotential lines), then there will be no electric field from the voltage multiplier circuit 80 and the field balancing circuit 100. The value of the voltage at these or other locations can vary so long as they are equivalent voltage points in these circuits 800, 100 so that radially there is no change in voltage and thus no electric field in the radial direction that would skew the electron beam away from the center of the X-ray tube 14. In the ideal case, if the circuits 800, 100 are perfectly matched, anywhere that such straight dotted lines are considered across the X-ray tube 14 at any point along the beam path 220, the voltage will be constant along those lines and there will be an absence of interfering electromagnetic fields.

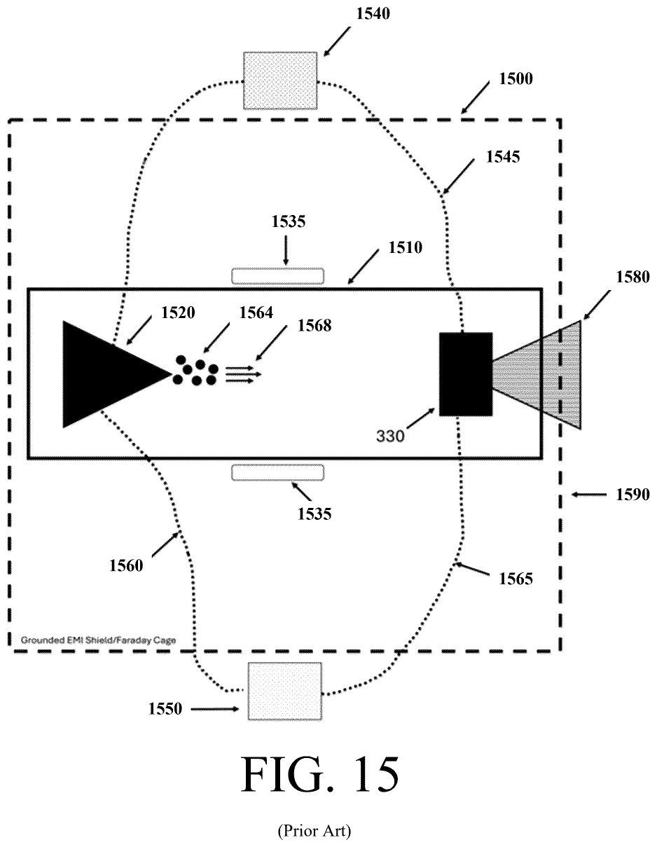

FIG. 15 depicts a prior art generator 1500 in which an X-ray tube 1510 has a cathode assembly 1520, an anode assembly 1530, and a focusing coil 1535. A voltage is applied to generate an electron cloud 1564 which is focused by the focusing coil 1535 into an electron beam 1568 which strikes a target at the anode assembly 1530 to generate an X-ray field 1580. A voltage multiplier circuit 1540 and voltage metering circuit 1550 are provided and connected between the cathode assembly 1520 and anode assembly 1530 by suitable circuitry 1545 and 1565. According to the prior art, such components must be distanced more than the distance between the cathode assembly 1520 and the anode assembly 1530. Also, the X-ray tube 1510 must be protected by electromagnetic shielding 1590 due to the inherent interference created by the electromagnetic fields generated by each of these components. Electromagnetic shielding 1590 is not necessary in the present solution, and the voltage multiplier circuit and voltage meter circuit can be located near or even on the X-ray tube.

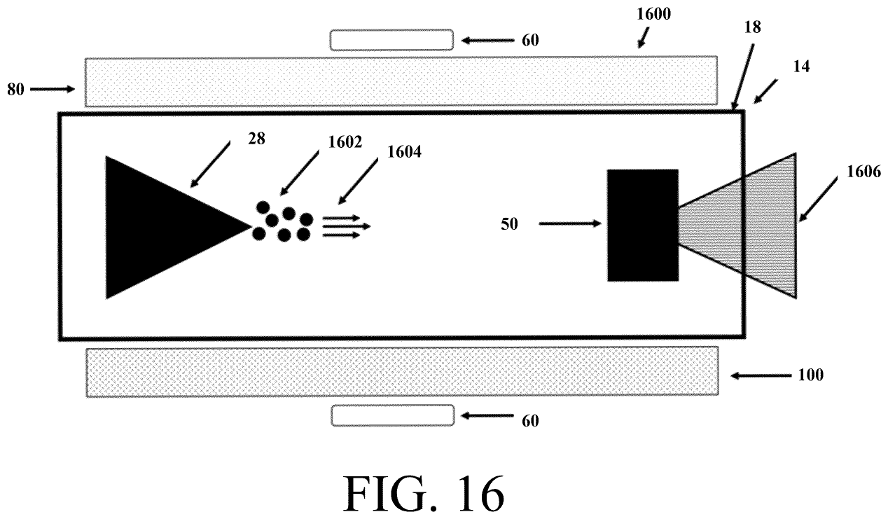

FIG. 16 shows a generator 1600 in accordance with the present solution. Generator 1600 can include X-Ray source 10 discussed above in relation to FIGS. 1-14. with an elongated X-ray tube 14, a cathode assembly 28, an anode assembly 50, and a focusing coil 60. Generator 1600 includes a voltage multiplier circuit 80 and a field balancing circuit 100 that are affixed directly to the outer surface 18 of the elongated X-ray tube 14. The focusing coil 60 is provided to focus an electron cloud 1602 into a beam 1604 which strikes a target in the anode assembly 50 to generate an X-ray field 1606.

FIGS. 17-20 provide illustrations that are useful for understanding operations of an X-ray source 10 in accordance with the present solution. FIG. 17 shows X-ray source 10 with certain components removed therefrom. The scenario of FIG. 17 shows an electron beam 1700 when X-ray tube 14, cathode assembly 28 and anode assembly 50 are present. It should be noted that voltage multiplier circuit 80, field balancing circuit 100 and field defining rings 70 are not being used in the scenario of FIG. 17. Electron beam field 1700 traverses a somewhat direct path between the cathode assembly 28 and the anode assembly 50.

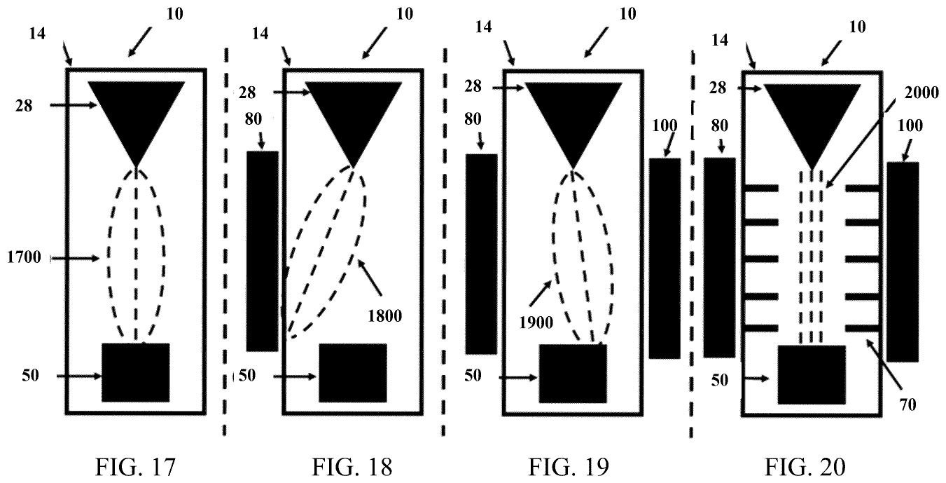

FIG. 18 shows the scenario in which the voltage multiplier circuit 80 is added to the assembly. The electron beam field 1800 is shown to divert from a direct path between the cathode assembly 28 and the anode assembly 50 due to the electromagnetic field created by the voltage multiplier circuit 180.

FIG. 19 shows the scenario in which the field balancing circuit 100 has been added to the assembly. The electron beam field 1980 passing from the cathode assembly 28 to the anode assembly 50 is seen to be more direct than in the scenario of FIG. 18 without a field balancing circuit 100.

FIG. 20 shows the scenario in which field defining rings 70 have been added to the assembly. The electron beam 2000 is shown to be better defined and directed between the cathode assembly 28 and the anode assembly 50 due to the presence of the field defining rings 70.

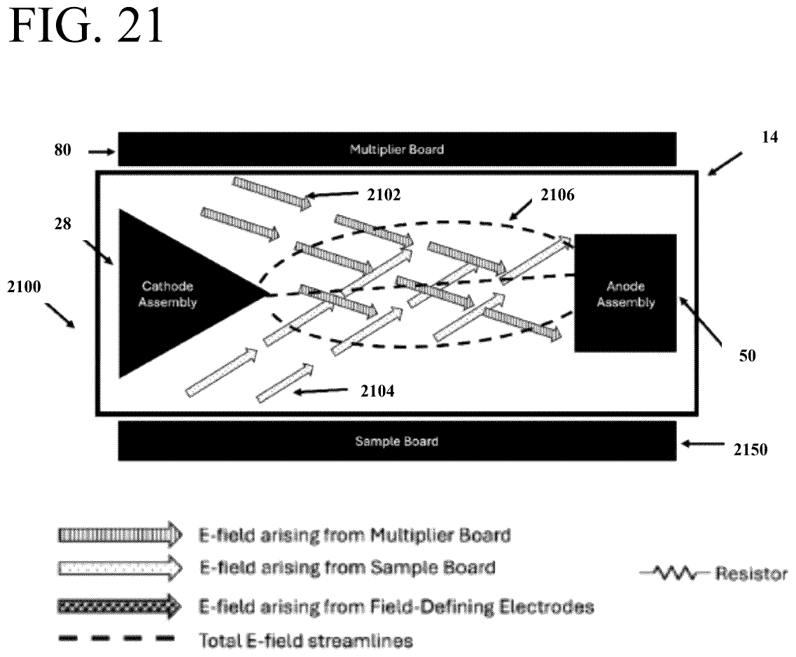

FIG. 21 shows another X-ray source 2100 in accordance with the present solution. X-ray source 2100 may be the same as or similar to X-ray source 10 discussed above. In the scenario of FIG. 21, the field balancing circuit 100 comprises a voltage meter circuit.

X-ray source 2100 comprises elongated X-ray tube 14, cathode assembly 28 and anode assembly 50. Voltage multiplier circuit 80 creates a voltage multiplier circuit electromagnetic field 2102. Voltage meter circuit 2150 creates a voltage meter circuit field balancing electromagnetic field 2104. The net electromagnetic field 2106 travels from the cathode assembly 28 to the anode assembly 50 in a direct path due to the opposing voltage meter circuit electromagnetic field 2102 and the field-balancing voltage meter circuit electromagnetic field 2104.

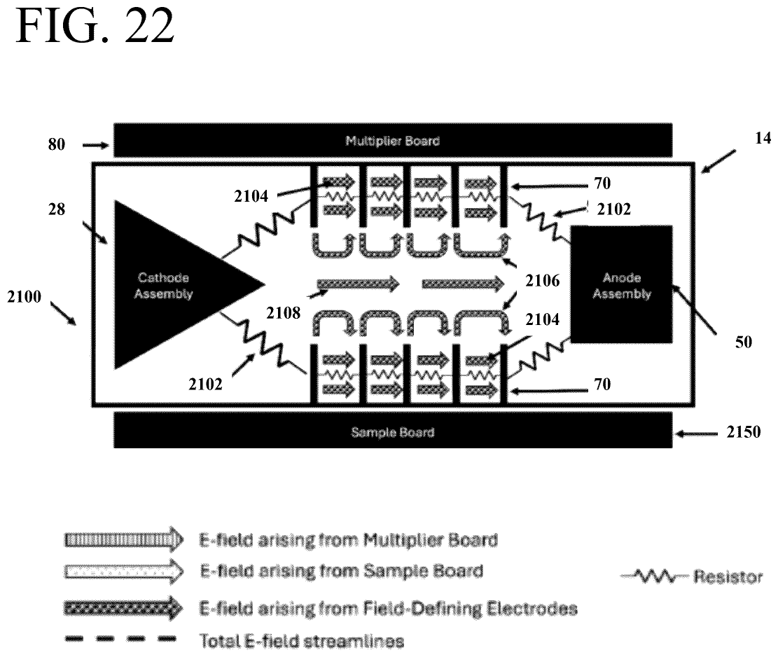

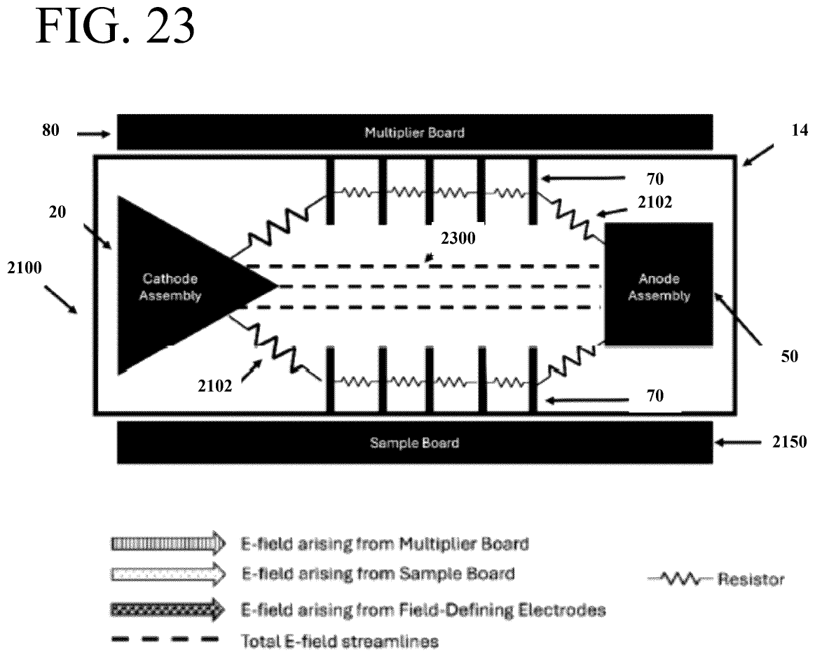

FIG. 22 shows the same X-ray source 2100 but with field shaping rings 70 added thereto. The field shaping rings 70 are connected by a circuit of resistors 2102 that is connected between the cathode assembly 28 and the anode assembly 50. This results in a stepped voltage between successive field shaping rings 70 resulting in electromagnetic fields 2104 between the field shaping rings 70, arced fields 2106 between laterally inward edges of the field shaping rings 70, and a central longitudinal field 2108. The result of all of the electromagnetic fields is shown in FIG. 23, where the net electromagnetic field 2300 is well-defined and well directed between the cathode assembly 28 and the anode assembly 50.

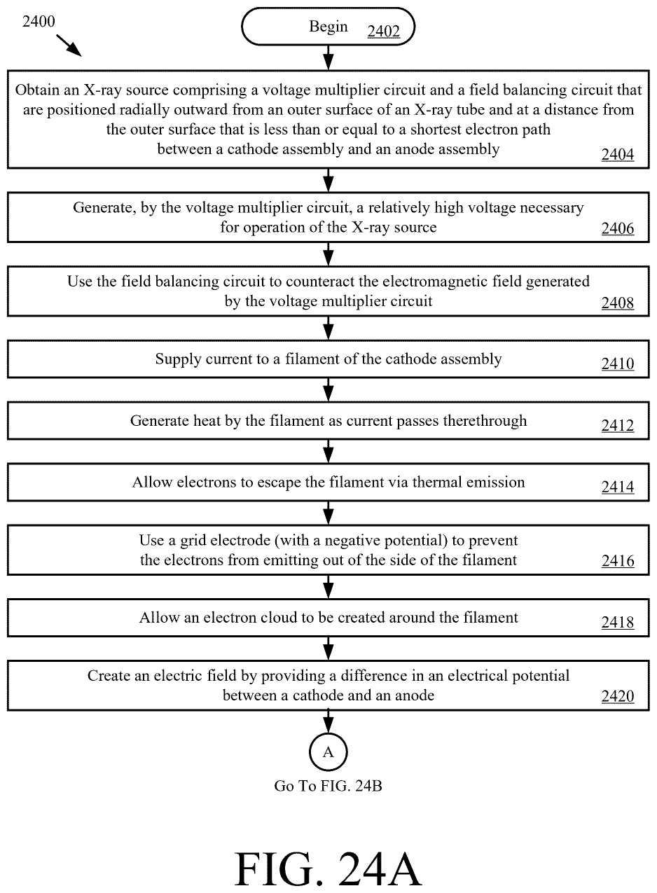

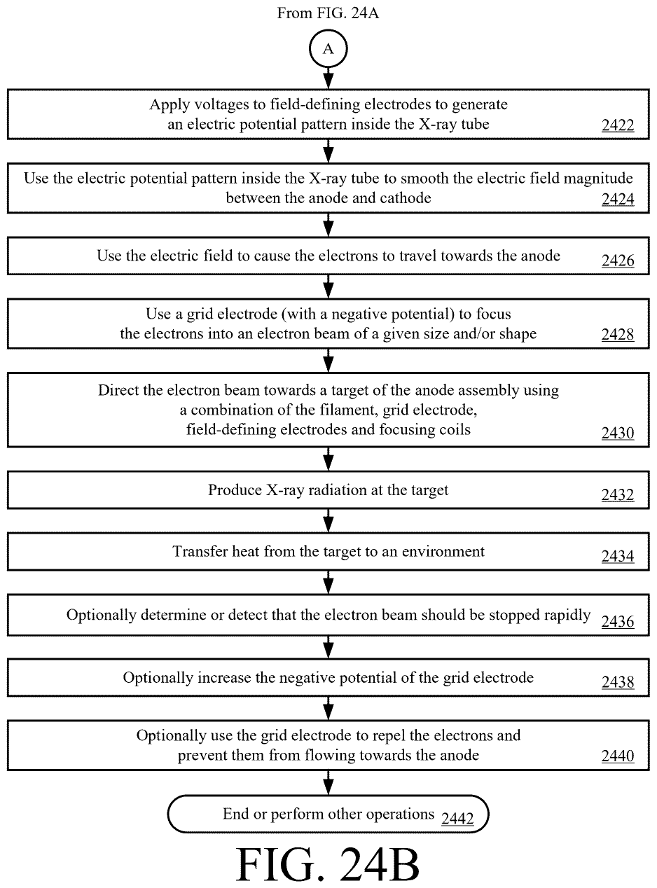

FIG. 24 provides a flow diagram of an illustrative method 2400 for operating an X-ray source (e.g., X-ray source 10 of FIGS. 1-14 and/or 2100 of FIGS. 21-23). Operations of method 2400 may be performed in the same or different order than that shown.

Method 2400 begins at block 2402 and continues to block 2404 where the X-ray source is obtained or otherwise provided. The X-ray source comprises a voltage multiplier circuit (e.g., voltage multiplier assembly or circuit 80 of FIG. 1) and a field balancing circuit (e.g., field balancing circuit 100 of FIG. 2) that are positioned radially outward from an outer surface (e.g., surface 18 of FIG. 1) of an X-ray tube (e.g., X-ray tube 14 of FIGS. 1-2) and at a distance from the outer surface that is less than or equal to a shortest electron path (e.g., path L of FIG. 11A).

In block 2406, the voltage multiplier circuit generates a relatively high voltage necessary for operation of the X-ray source. The voltage multiplier circuit produces a voltage multiplier electromagnetic field. The field balancing circuit is used in block 2408 to counteract the electromagnetic field generated by the voltage multiplier circuit.

Next in block 2408, current is supplied to a filament (e.g., filament 38 of FIG. 3) of the cathode assembly. Heat is generated by the filament as shown by block 2412. Electrons are allowed to escape the filament via thermal emission in block 2414.

A grid electrode (e.g., grid electrode 30 of FIG. 3) is used in block 2416 to prevent the electrons from emitting out of the side of the filament. The grid electrode has a negative potential. In block 2418, an electron cloud is allowed to be created around the filament. An electric field is created in block 2420 by providing a difference in an electrical potential between a cathode (e.g., cathode 38 of FIG. 3) and an anode (e.g., anode 52 of FIG. 6). Method 2400 then continues to block 2422 of FIG. 24B.

Block 2422 involves applying voltages to field-defining electrodes (e.g., field-defining electrodes 70 of FIG. 2) to generate an electric potential pattern inside the X-ray tube. The electric potential pattern is used in block 2426 to cause the electrons to travel towards the anode. The grid electrode is used in block 2428 to focus the electrons into an electron beam of a given size and/or shape. The electron beam is directed in block 2430 towards a target of the anode assembly using a combination of the filament, grid electrode, field-defining electrodes and focusing coils. In block 2432, X-ray radiation is produced at the target. Heat is transferred from the target in block 2434.

Method 2400 may continue with optional operations of blocks 2436-2440. These operations involve: determine or detect that the electron beam should be stopped rapidly; increase the negative potential of the grid electrode; and/or use the grid electrode to repel the electrons and prevent them from flowing towards the anode. Subsequently, method 2400 continues to block 2442 where it ends or other operations are performed. The other operations can include, but are not limited to, returning to block 2402 of FIG. 24A.

Without excluding further possible embodiments, certain example embodiments are summarized in the following clauses.

Clause 1: An X-ray source, comprising: an elongated-ray tube having an outer surface and an open interior and first and second ends, a cathode and an anode in the open interior wherein the cathode is nearest the first end and the anode is nearest the second end, the cathode and anode being separated by a length L, and a target in the open interior nearer the second end than the first end, the target comprising a material that when impacted by the electron beam generates Bremsstrahlung X-ray photons, the cathode and the target defining an electron beam path for an electron beam; a voltage multiplier circuit comprising capacitors and diodes; and a field balancing circuit. The passive components of the voltage multiplier circuit and/or the passive components of the field balancing circuit are positioned radially outward from the outer surface of the elongated X-ray tube to a distance that is less than or equal to the distance L, and are axially distributed between the cathode and the anode. During operation of the X-ray source, the voltage multiplier circuit produces a voltage multiplier electromagnetic field, and the field balancing circuit produces a field balancing electromagnetic field that counteracts the voltage multiplier electromagnetic field such that the electron beam path is unaffected by the voltage multiplier electromagnetic field. The passive components can include, but are not limited to, capacitors and/or diodes.

Clause 2: The X-ray source of claim 1, wherein the voltage multiplier circuit and the field balancing circuit are positioned radially outward from the electron beam path from the outer surface of the elongated X-ray tube to a distance that is less than the distance 0.500 L.

Clause 3: The X-ray source of any preceding claim, wherein the voltage multiplier circuit and the field balancing circuit are positioned radially outward from the electron beam path from the outer surface of the elongated X-ray tube to a distance that is less than the distance 0.250 L.

Clause 4: The X-ray source of any preceding claim, wherein the voltage multiplier circuit and the field balancing circuit are attached to the outer surface of the elongated X-ray tube.

Clause 5: The X-ray source of any preceding claim, wherein the field balancing circuit comprises a voltage meter circuit comprising a series of resistors electrically connected between the anode and the cathode for measuring the voltage between the anode and the cathode.

Clause 6: The X-ray source of any preceding claim, wherein a portion of the voltage multiplier circuit comprising the capacitors and diodes of the voltage multiplier circuit is affixed to the outer surface of the elongated X-ray tube.

Clause 7: The X-ray source of any preceding claim, wherein the field balancing circuit is affixed to the outer surface of the elongated X-ray tube.

Clause 8: The X-ray source of any preceding claim, wherein the elongated X-ray tube has longitudinal half sections, and the voltage multiplier circuit and field balancing circuit are positioned radially outward from different ones of the longitudinal half sections.

Clause 9: The X-ray source of any preceding claim, wherein the target is the anode.

Clause 10: The X-ray source of any preceding claim, wherein the target is electrically separated from the anode.

Clause 11: The X-ray source of any preceding claim, wherein there is no EMI shield between the voltage multiplier circuit and the field balancing circuit and the X-ray tube.

Clause 12: A method of generating an X-ray beam, comprising: obtaining an X-ray source comprising a voltage multiplier circuit and a field balancing circuit that are positioned adjacent to and radially outward from an outer surface of an X-ray tube; generating, by the voltage multiplier circuit, a voltage for operation of the X-ray source and a voltage multiplier electromagnetic field; producing, by the field balancing circuit, a field balancing electromagnetic field that counteracts the voltage multiplier electromagnetic field; and operating the X-ray source to generate X-ray radiation.

Clause 13: The method according to clause 12, wherein the voltage multiplier circuit and the field balancing circuit are positioned at a distance from the outer surface that is less than or equal to a shortest electron path between a cathode and an anode of the X-ray source.

Clause 14: The method according to any preceding method clause, wherein passive components of the voltage multiplier circuit and/or passive components of the filed balancing circuit are axially distributed between a cathode and an anode of the X-ray source. The passive components can include, but are not limited to, capacitors and/or diodes.

Clause 15: The method according to any preceding method clause, further comprising: supplying current to a filament of a cathode assembly; generating heat by the filament as current passes therethrough; and allowing electrons to escape the filament via thermal emission.

Clause 16: The method according to any preceding method clause, further comprising using a grid electrode to prevent the electrons from emitting out of a side of the filament, wherein the grid electrode has a negative potential.

Clause 17: The method according to any preceding method clause, further comprising selectively increasing the negative potential of the grid electrode so that the grid electrode prevents the electrons from flowing towards an anode of the X-ray source.

Clause 18: The method according to any preceding method clause, wherein the negative potential of the grid electrode is selectively increased when the electron beam is to be stopped in a rapid manner.

Clause 19: The method according to any preceding method clause, further comprising: allowing an electron cloud to be created around the filament; and creating an electric field by providing a difference in an electrical potential between a cathode and an anode of the X-ray source.

Clause 20: The method according to any preceding method clause, further comprising: applying voltages to field-defining electrodes to generate an electric potential pattern inside the X-ray tube; and using the electric potential pattern inside the X-ray tube to smooth an electric field magnitude between the cathode and the anode.

Clause 21: The method according to any preceding method clause, further comprising: using the electric field to cause the electrons to travel towards the anode; using a grid electrode to focus the electrons into an electron beam of a given size and/or a given shape; and directing the electron beam towards a target of an anode assembly using a combination of the filament, the grid electrode, field-defining electrodes, and focusing coils.

Clause 22: The method according to any preceding method clause, further comprising generating Bremsstrahlung X-ray photons by the target when impacted by the electron beam.

Clause 23: An X-ray source, comprising: an X-ray tube; a voltage multiplier circuit positioned adjacent to and radially outward from an outer surface of an X-ray tube, and configured to generate a voltage for operation of the X-ray source so that X-ray radiation is generated, wherein the voltage multiplier circuit produces a voltage multiplier electromagnetic field; and a field balancing circuit positioned adjacent to and radially outward from an outer surface of an X-ray tube, and configured to produce a field balancing electromagnetic field that counteracts the voltage multiplier electromagnetic field.

Clause 24: The X-ray source according to clause 23, wherein the voltage multiplier circuit and the field balancing circuit are positioned at a distance from the outer surface that is less than or equal to a shortest electron path between a cathode and an anode of the X-ray source.

Clause 25: The X-ray source according to any preceding X-ray source clause, wherein passive components of the voltage multiplier circuit and/or passive components of the filed balancing circuit are axially distributed between a cathode and an anode of the X-ray source. The passive components can include, but are not limited to, capacitors and/or diodes.

Clause 26: The X-ray source according to any preceding X-ray source clause, further comprising a filament to which current is supplied and that generates heat as current passes therethrough, wherein electrons are allowed to escape the filament via thermal emission.

Clause 27: The X-ray source according to any preceding X-ray source clause, further comprising a grid electrode used to prevent the electrons from emitting out of a side of the filament, wherein the grid electrode has a negative potential.

Clause 28: The X-ray source according to any preceding X-ray source clause, wherein the negative potential of the grid electrode is increased or selectively increased so that the grid electrode prevents the electrons from flowing towards an anode of the X-ray source.

Clause 29: The X-ray source according to any preceding X-ray source clause, wherein the negative potential of the grid electrode is selectively increased when the electron beam is to be stopped in a rapid manner.

Clause 30: The X-ray source according to any preceding X-ray source clause, wherein: an electron cloud is created around the filament; and an electric field is created by providing a difference in an electrical potential between a cathode and an anode of the X-ray source.

Clause 31: The X-ray source according to any preceding X-ray source clause, further comprising field-defining electrodes to which voltages are applied for generating an electric potential pattern inside the X-ray tube, wherein the electric potential pattern inside the X-ray tube smooths an electric field magnitude between the cathode and the anode.

Clause 32: The X-ray source according to any preceding X-ray source clause, wherein the electric field causes the electrons to travel towards the anode, a grid electrode focuses the electrons into an electron beam of a given size and/or a given shape, and the electron beam is directed towards a target of an anode assembly using a combination of the filament, the grid electrode, field-defining electrodes, and focusing coils.

Clause 33: The X-ray source according to any preceding X-ray source clause, wherein Bremsstrahlung X-ray photons are generated by the target when impacted by the electron beam.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

1.-12. (canceled)

13. An X-ray source, comprising:
an elongated X-ray tube having an outer surface and an open interior and first and second ends, a cathode and an anode in the open interior wherein the cathode is nearest the first end and the anode is nearest the second end, the cathode and anode being separated by a length L, and a target in the open interior nearer the second end than the first end, the target comprising a material that when impacted by the electron beam generates Bremsstrahlung X-ray photons, the cathode and the target defining an electron beam path for an electron beam;
a voltage multiplier circuit; and
a field balancing circuit;
wherein passive components of both the voltage multiplier circuit and the field balancing circuit are positioned radially outward from the outer surface of the elongated X-ray tube to a distance that is less than or equal to the distance L, and are axially distributed between the cathode and the anode;
wherein during operation of the X-ray source the voltage multiplier circuit produces a voltage multiplier electromagnetic field, and the field balancing circuit produces a field balancing electromagnetic field that counteracts the voltage multiplier electromagnetic field such that the electron beam path is unaffected by the voltage multiplier electromagnetic field; and
wherein the elongated X-ray tube has longitudinal half sections, and the voltage multiplier circuit and field balancing circuit are positioned radially outward from different ones of the longitudinal half sections.

14. The X-ray source of claim 13, wherein the voltage multiplier circuit and the field balancing circuit are positioned radially outward from the electron beam path from the outer surface of the elongated X-ray tube to a distance that is less than the distance 0.500 L.

15. The X-ray source of claim 13, wherein the voltage multiplier circuit and the field balancing circuit are positioned radially outward from the electron beam path from the outer surface of the elongated X-ray tube to a distance that is less than the distance 0.250 L.

16. The X-ray source of claim 13, wherein the voltage multiplier circuit and the field balancing circuit are attached to the outer surface of the elongated X-ray tube.

17. An X-ray source, comprising:
an elongated X-ray tube having an outer surface and an open interior and first and second ends, a cathode and an anode in the open interior wherein the cathode is nearest the first end and the anode is nearest the second end, the cathode and anode being separated by a length L, and a target in the open interior nearer the second end than the first end, the target comprising a material that when impacted by the electron beam generates Bremsstrahlung X-ray photons, the cathode and the target defining an electron beam path for an electron beam;
a voltage multiplier circuit; and
a field balancing circuit;
wherein passive components of both the voltage multiplier circuit and the field balancing circuit are positioned radially outward from the outer surface of the elongated X-ray tube to a distance that is less than or equal to the distance L, and are axially distributed between the cathode and the anode;
wherein during operation of the X-ray source the voltage multiplier circuit produces a voltage multiplier electromagnetic field, and the field balancing circuit produces a field balancing electromagnetic field that counteracts the voltage multiplier electromagnetic field such that the electron beam path is unaffected by the voltage multiplier electromagnetic field; and
wherein the field balancing circuit comprises a voltage meter circuit comprising a series of resistors electrically connected between the anode and the cathode for measuring the voltage between the anode and the cathode.

18. The X-ray source of claim 13, wherein a portion of the voltage multiplier circuit comprising the capacitors and diodes of the voltage multiplier circuit is affixed to the outer surface of the elongated X-ray tube.

19. The X-ray source of claim 18, wherein the field balancing circuit is affixed to the outer surface of the elongated X-ray tube.

20. (canceled)

21. The X-ray source of claim 13, wherein the target is the anode.

22. The X-ray source of claim 13, wherein the target is electrically separated from the anode.

23. The X-ray source of claim 13, wherein there is no electromagnetic interference shield between the voltage multiplier circuit and the field balancing circuit and the X-ray tube.
